(19) United States
(12) Patent Application Publication
(10) Pub. No.: US 2025/0362569 A1
(43) Pub. Date: Nov. 27, 2025

(54) LENS APPARATUS AND IMAGING APPARATUS

(71) Applicant: CANON KABUSHIKI KAISHA, Tokyo (JP)

(72) Inventor: TOSHIMUNE NAGANO, Saitama (JP)

(21) Appl. No.: 19/206,444

(22) Filed: May 13, 2025

(30) Foreign Application Priority Data
May 21, 2024 (JP) 2024-082416

(51) Int. Cl. G03B 13/34; G03B 17/14

(52) U.S. Cl. CPC G03B 13/34; G03B 17/14

(57) ABSTRACT

A lens apparatus includes a moving member configured to hold a lens and to be movable in an optical axis direction, a holding barrel configured to hold the moving member, and a driving mechanism configured to move the moving member. The driving mechanism includes a coil held by the moving member and a magnetic material portion held by the holding barrel. An outer periphery of the holding barrel is provided with an opening portion. When viewed in the optical axis direction, a part of the outer periphery overlaps with a part of the magnetic material portion so that the part of the outer periphery is arranged outside the part of the magnetic material portion.

### BACKGROUND OF THE DISCLOSURE

### Field of the Disclosure

The present disclosure relates to relates to a lens apparatus including a moving member configured to hold a lens and be movable, and to an imaging apparatus.

### Description of the Related Art

In a lens apparatus used in an imaging apparatus (optical device) such as a video camera or a digital camera, a driving mechanism configured to drive a lens and a barrel holding the lens in an optical axis direction is used. The lens apparatus can improve optical performance by using a large lens. In order to move a lens larger than a conventional lens, a driving mechanism that generates a driving force by using, for example, magnets and a coil has been proposed. Japanese Patent Application Laid-Open No. 2020-64284 discloses the driving mechanism provided on an outer periphery of a barrel that holds the lens inside a lens apparatus. The Japanese Patent Application Laid-Open No. 2020-64284 discloses that the larger driving mechanism can be accommodated inside the lens apparatus without enlarging the lens apparatus by offsetting a center of the coil to the outside of centers of the magnets.

### SUMMARY OF THE DISCLOSURE

According to an aspect of the present disclosure, a lens apparatus includes: a moving member configured to hold a lens and to be movable in an optical axis direction; a holding barrel configured to hold the moving member; and a driving mechanism configured to move the moving member, wherein the driving mechanism includes: a coil held by the moving member; and a magnetic material portion held by the holding barrel, wherein an outer periphery of the holding barrel is provided with an opening portion, and wherein when viewed in the optical axis direction, a part of the outer periphery overlaps with a part of the magnetic material portion so that the part of the outer periphery is arranged outside the part of the magnetic material portion.

According to another aspect of the present disclosure, an imaging apparatus includes: the lens apparatus described above; and an image sensor configured to pick up an image formed by the lens apparatus.

Further features of the present disclosure will become apparent from the following description of exemplary embodiments with reference to the attached drawings.

### BRIEF DESCRIPTION OF THE DRAWINGS

FIG. 1 is a cross-sectional view of an imaging apparatus of a first embodiment.

FIG. 2A and FIG. 2B are perspective views of a fourth group unit of the first embodiment.

FIG. 3 is a plan view of the fourth group unit of the first embodiment.

FIG. 4 is a perspective view of a base which holds a driving mechanism portion of the first embodiment.

FIG. 5A and FIG. 5B are explanatory views of the driving mechanism portion of the first embodiment.

FIG. 6 is a view of the base, in which the driving mechanism portion of the first embodiment is incorporated, as viewed from the rear.

FIG. 7 is a schematic view showing a relationship between the driving mechanism portion and a connecting portion of the first embodiment.

FIG. 8 is a schematic view showing a relationship among abutting positions of a back yoke, a front base yoke, and a rear base yoke of the first embodiment.

FIG. 9 is a cross-sectional view showing a holding relationship between a coil and a barrel base of the first embodiment.

FIG. 10 is a perspective view of a driving mechanism portion of a second embodiment.

FIG. 11 is a schematic view showing a relationship between a driving mechanism portion and a connecting portion of a third embodiment.

FIG. 12 is a schematic view showing a relationship between a driving mechanism portion and a connecting portion of a fourth embodiment.

FIG. 13 is a schematic view showing a relationship between a driving mechanism portion and a connecting portion of a fifth embodiment.

### DESCRIPTION OF THE EMBODIMENTS

The embodiments will be described in detail below based on the accompanying drawings.

### First Embodiment

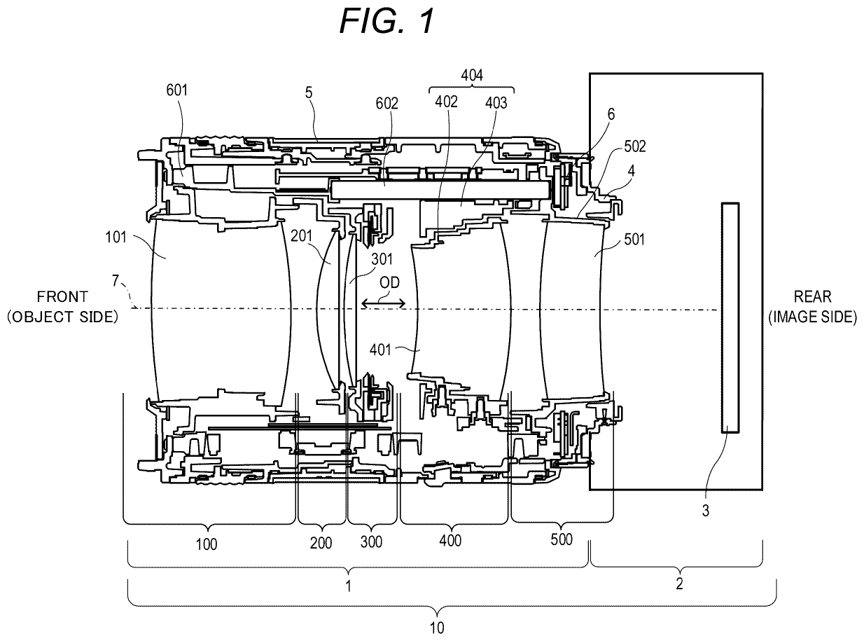

FIG. 1 is a cross-sectional view of an imaging apparatus 10 of a first embodiment. The imaging apparatus 10 includes a lens barrel (lens apparatus) 1 and a camera body 2. The camera body 2 includes an image sensor 3 configured to pick up an image formed by the lens barrel 1. The camera body 2 is configured to pick up the image formed through the lens barrel 1. The lens barrel 1 is provided with a mount 4. The lens barrel 1 is fixed to the camera body 2 by connecting the mount 4 to a mount provided in the camera body 2. The lens barrel 1 is an interchangeable lens detachably mounted on the camera body 2. The lens barrel 1 is not necessarily an interchangeable lens but may be fixedly mounted on the camera body 2, or may be configured integrally with the camera body 2.

The lens barrel 1 has a lens 101, a lens 201, a lens 301, a lens 401 and a lens 501 as optical elements in the order from an object side (left side in FIG. 1) to an image side (right side in FIG. 1). The lens barrel 1 has a first group unit 100, a second group unit 200, a third group unit 300, a fourth group unit 400, and a fifth group unit 500 holding the lens 101, the lens 201, the lens 301, the lens 401, and the lens 501, respectively. The first group unit 100, the second group unit 200, the third group unit 300, the fourth group unit 400, and the fifth group unit 500 are held by a base 601.

The second group unit 200 and the fourth group unit 400 are respectively guided by a guide bar and constitute focus groups which can be driven and controlled by a driving mechanism in focusing. When an operator rotates an operation ring 5, an positional relationship of each of the second group unit 200 and the fourth group unit 400 in a direction along an optical axis 7 (hereinafter referred to as an optical axis direction OD) is changed so that a focus position of the lens barrel 1 is changed. The respective driving mechanisms are driven and controlled by a main CPU 6. Since the driving mechanism of the second group unit 200 is a known configuration using a vibrator, a detailed description thereof will be omitted. The driving mechanism of the fourth group unit 400 is a voice coil motor (VCM), and a detailed description thereof will be provided later. The main CPU 6 of the lens barrel 1 performs the above-described control by communicating with a main CPU provided in the camera body 2.

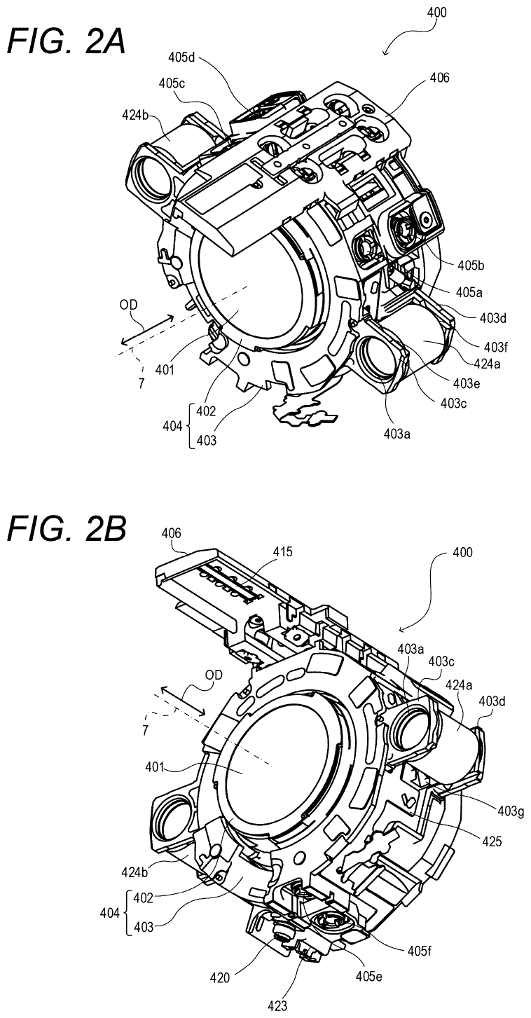

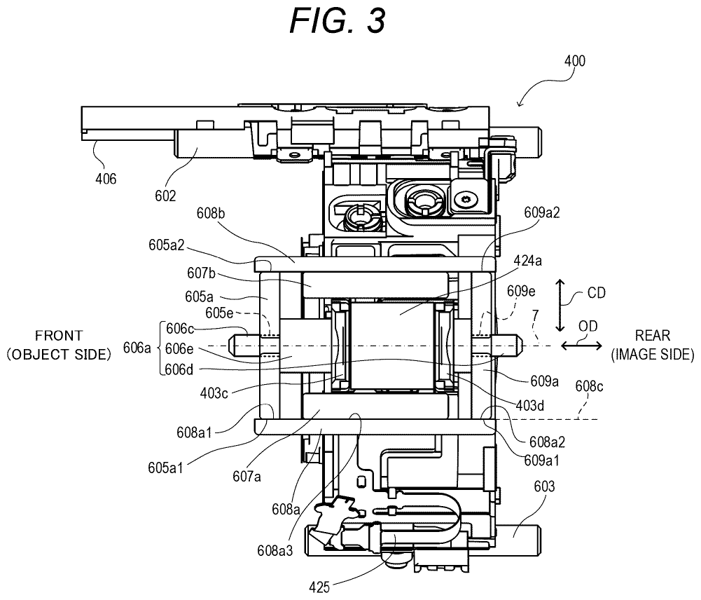

FIG. 2A and FIG. 2B are perspective views of the fourth group unit 400 of the first embodiment. FIG. 3 is a plan view of the fourth group unit 400 of the first embodiment. The lens 401 held by the fourth group unit 400 is fixed to the lens barrel 402. The lens barrel 402 is held by a barrel base 403 so as to be adjustable by an adjustment roller 405a, an adjustment roller 405b, an adjustment roller 405c, an adjustment roller 405d, an adjustment roller 405e, and an adjustment roller 405f. The lens barrel 402 and the barrel base 403 constitute a barrel unit 404 (moving member). Since an adjustment by the adjustment rollers 405a, 405b, 405c, 405d, 405e, and 405f is known, a description thereof is omitted.

The barrel unit 404 holds the lens 401 and is held by the base (holding barrel) 601 so as to be movable in the optical axis direction OD. A guide unit 406 guided by a main guide bar 602 fixed to the base 601 is fixed to the barrel unit 404. By adjusting a ball bearing as a rotation element provided in the guide unit 406 and rolling with respect to the main guide bar 602, a tilt component and the guide direction of the barrel unit 404 with respect to the base 601 are adjusted.

A ball bearing configured to allow the barrel unit 404 to be guided by a sub-guide bar 603 fixed to the base 601 is held by the barrel unit 404 so as to be rotatable by a shaft screw 420. With this configuration, an eccentric component of the lens 401 with respect to the optical axis 7 of the lens barrel 1 is adjusted. The barrel unit 404 is urged to the sub-guide bar 603 by a sub-magnet fixed to a sub-yoke 423 so that the ball bearing contacts the sub-guide bar 603. One end portion of each of the main guide bar 602 and the sub-guide bar 603 is held by the base 601, and the other end thereof is held by a fifth lens barrel 502 in the fifth group unit 500.

The barrel unit 404 holds coils 424a and 424b constituting the driving mechanism configured to move the barrel unit 404 in the optical axis direction OD relative to the base 601. The barrel unit 404 holds a flexible cable 425 configured to pass current to the coils 424a and 424b. The flexible cable 425 forms a U-turn portion between the base 601 and the barrel base 403, so that the barrel base 403 can move in the optical axis direction OD (guide direction) relative to the base 601. A position of the barrel unit 404 in the optical axis direction OD is detected by using a scale 415 as position detecting means, and the control is performed so that the barrel unit 404 is held at an arbitrary position by using the driving mechanism described later.

Next, a configuration of a magnetic circuit of the driving mechanism will be described. In the first embodiment, the object side will be described as a front side, and the image side will be described as a rear side. A center yoke (first magnetic material portion) 606a is arranged inside the coil 424a apart from an inner periphery (inner peripheral surface) of the coil 424a (with a clearance (gap) between the center yoke 606a and the inner periphery of the coil 424a) and is fixed to the base 601. On the front side and the rear side of the center yoke 606a with respect to the optical axis direction OD, a front base yoke 605a and a rear base yoke 609a are attracted by VCM magnets (a plurality of magnets) 607a and 607b described later, and are in contact with the center yoke 606a, respectively.

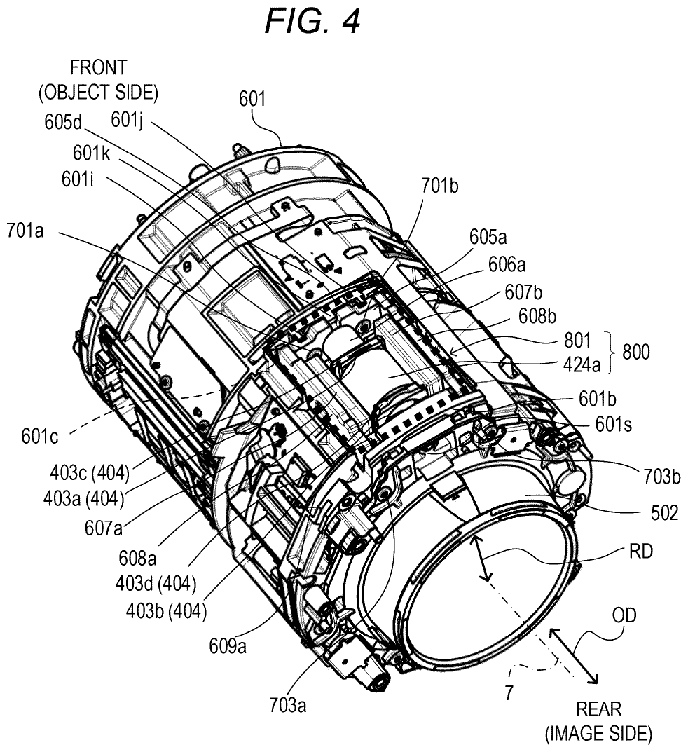

The front base yoke (third magnetic material portion) 605a is arranged on the front side (one side) of the center yoke 606a with respect to the optical axis direction OD, and magnetically joins the center yoke 606a and back yokes 608a and 608b (a plurality of second magnetic material portions). The front base yoke 605a is arranged in abutment with the base 601 in the optical axis direction OD on the front side of the center yoke 606a with respect to the optical axis direction OD. The front base yoke 605a is fixed to the base 601 with screws (fixing members) 701a and 701b (FIG. 4) from a side on which the center yoke 606a is arranged. The rear base yoke (fourth magnetic material portion) 609a is arranged on the rear side (the other side) of the center yoke 606a with respect to the optical axis direction OD, and magnetically joins the center yoke 606a and the back yokes 608a and 608b.

The front base yoke 605a is provided with flat surface portions 605a1 and 605a2 having substantially the same distance from the optical axis 7 on both sides with respect to the optical axis 7 in a circumferential direction CD orthogonal to the optical axis direction OD. Similarly, the rear base yoke 609a is provided with flat surface portions 609a1 and 609a2 having substantially the same distance from the optical axis 7 on both sides with respect to the optical axis 7 in the circumferential direction CD orthogonal to the optical axis direction OD. The flat surface portions 605a1, 605a2, 609a1 and 609a2 of the front base yoke 605a and the rear base yoke 609a are substantially parallel. The VCM magnets 607a and 607b are magnetically attracted and fixed to coil sides of the back yokes 608a and 608b (the plurality of second magnetic material portions), respectively. The VCM magnets 607a and 607b are arranged so that the same poles face the coil 424a. The VCM magnets 607a and 607b are arranged opposite to an outer periphery of the coil 424a and apart from the outer periphery of the coil 424a. A first contact surface 608a1 and a second contact surface 608a2 of the back yoke 608a to which the VCM magnet 607a is attracted are attracted and held by the flat surface portion 605a1 of the front base yoke 605a and the flat surface portion 609a1 of the rear base yoke 609a. The back yoke 608b to which the VCM magnet 607b is attracted is attracted and held by the flat surface portion 605a2 of the front base yoke 605a and the flat surface portion 609a2 of the rear base yoke 609a. The magnetic circuit is configured by the above constructions.

In the first embodiment, the back yokes 608a and 608b, the front base yoke 605a, and the rear base yoke 609a are separate bodies, but they are not necessarily separate bodies. For example, the back yoke 608a and the front base yoke 605a may be integrally formed into one body, the back yoke 608b and the front base yoke 605a may be integrally formed into one body, and the back yokes 608a and 608a and the front base yoke 605a may be integrally formed into one body. For example, the center yoke 606a, the front base yoke 605a, and the back yokes 608a and/or 608b may be integrally formed or one body.

Although details are omitted, the coil 424b has the same structure. The barrel unit 404 can be moved in the guide direction by applying current to the respective coils 424a and 424b. Since the detailed principle and control are known techniques, they are omitted.

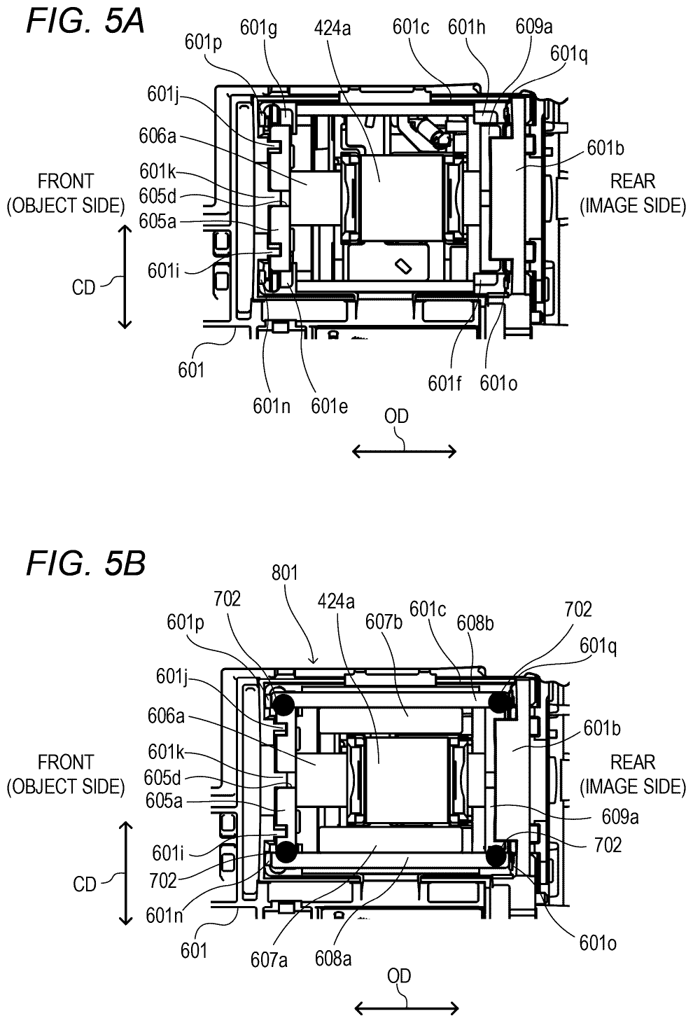

FIG. 4 is a perspective view of the base 601 which holds a driving mechanism portion 801 of the first embodiment. FIG. 5A and FIG. 5B are explanatory views of the driving mechanism portion 801 of the first embodiment. The driving mechanism 800 configured to drive the barrel unit 404 has the driving mechanism portion 801 and the coil 424a. The driving mechanism portion 801 includes the front base yoke 605a, the center yoke 606a, the VCM magnets 607a and 607b, the back yokes 608a and 608b, and the rear base yoke 609a. FIG. 5A shows the front base yoke 605a, the center yoke 606a, and the rear base yoke 609a, which are attached to the base 601, of the driving mechanism portion 801. FIG. 5B shows the driving mechanism portion 801 attached to the base 601. The front base yoke 605a is fixed to the base 601 by screws (fixing members) 701a and 701b screwed from the rear side toward the front side with respect to the optical axis direction OD. An opening portion 601s is provided on the rear side of the base 601, and the lens barrel 404 is inserted into the base 601 through the opening portion 601s. In other words, since the screws 701a and 701b can be tightened from the rear side of the base 601, there is no need to provide a fixing portion to which the screws 701a and 701b are tightened from the front side of the base 601. In other words, a fixing portion for the lens barrel (third group unit 300) assembled from the front side can be provided on a portion of the base 601 on the front side of the driving mechanism portion 801. Moreover, a guide bar configured to guide a movable group (second group unit 200) can be provided on a portion of the base 601 on the front side of the driving mechanism portion 801. Thus, it is not necessary to arrange the components of other barrels avoiding the fixing portion, and the base 601 can be miniaturized in the direction orthogonal to the optical axis 7 (hereinafter referred to as a radial direction RD).

As shown in FIG. 3, the center yoke 606a has a front cylindrical portion 606c, a center cylindrical portion 606e, and a rear cylindrical portion 606d. The front cylindrical portion 606c is provided on the front side of the center cylindrical portion 606e, and the rear cylindrical portion 606d is provided on the rear side of the center cylindrical portion 606e. The center cylindrical portion 606e is disposed so as to penetrate the inside of the coil 424a and has a diameter so as to be arranged apart from the inner periphery of the coil 424a with a clearance. A diameter of the front cylindrical portion 606c and a diameter of the rear cylindrical portion 606d are smaller than the diameter of the center cylindrical portion 606e.

The front base yoke 605a is provided with a hole 605e. The front cylindrical portion 606c extends through the hole 605e of the front base yoke 605a and is inserted into a hole of the base 601 to determine a position of the center yoke 606a in the optical axis direction OD. The center yoke 606a abuts against the front base yoke 605a at a stepped portion which is a portion different between the diameter of the center cylindrical portion 606e and the diameter of the front cylindrical portion 606c.

The coil 424a is assembled to the center yoke 606a while being fixed to the barrel base 403. As shown in FIG. 2A, the coil 424a is held between a front holding portion (first covering portion) 403c and a rear holding portion (second covering portion) 403d provided in the barrel base 403. The front holding portion 403c and the rear holding portion 403d are provided on the outer periphery of the barrel base 403 and extend from the outer periphery of the barrel base 403 to the outside in the radial direction RD. The front holding portion 403c is provided with a front hole portion 403a. The rear holding portion 403d is provided with a rear hole portion 403b. The center yoke 606a extends through the front hole portion 403a of the front holding portion 403c, the coil 424a, and the rear hole portion 403b of the rear holding portion 403d. The detailed structure will be described later. Since the barrel base 403 is held by the main guide bar 602 and the sub-guide bar 603 of the base 601 and the center yoke 606a is held by the base 601, the coil 424a is held apart from the center yoke 606a.

With the coil 424a assembled on the center yoke 606a, the rear base yoke 609a can be assembled on the center yoke 606a from the rear side of the base 601 through the opening portion 601s. The rear base yoke 609a is provided with a hole 609e. Though the details will be provided later, the rear cylindrical portion 606d of the center yoke 606a is inserted into the hole 609e of the rear base yoke 609a so that the rear base yoke 609a is assembled on the center yoke 606a. The rear cylindrical portion 606d of the center yoke 606a is fitted and held in a hole provided in the fifth lens barrel 502 fixed to the base 601 on the rear side of the fourth group unit 400.

FIG. 5A shows a state in which the front base yoke 605a, the center yoke 606a, and the rear base yoke 609a are attached to the base 601 as described above. A united state of the VCM magnet 607a and the back yoke 608a, and a united state of the VCM magnet 607b and the back yoke 608b are assembled into the base 601 in this state to constitute the driving mechanism portion 801 as shown in FIG. 5B.

The base 601 is provided with a hole portion (an outer diameter hole portion) 601c (indicated by a dotted line in FIG. 4) in the outer periphery of the base 601. The hole portion 601c has a size that allows each of the VCM magnets 607a and 607b and the back yokes 608a and 608b to pass through the hole portion 601c. In the first embodiment, the united state of the VCM magnet 607a and the back yoke 608a can be assembled into the inside of the base 601 from the outside of the outer periphery of the base 601 through the hole portion 601c. The back yokes 608a and 608b can be seen from the outside of the outer periphery of the base 601 through the hole portion 601c. As viewing the hole portion 601c from the outside of the outer periphery of the base 601 along the radial direction RD orthogonal to the optical axis direction OD, the hole portion 601c is larger than the united state of the VCM magnet 607a and the back yoke 608a. That is, the united state of the VCM magnet 607a and the back yoke 608a can be assembled into the base 601 that is in an assembled state as shown in FIG. 5A through the hole portion 601c from the outside of the outer periphery of the base 601. The VCM magnets 607a and 607b are arranged opposite to the outer periphery of the coil 424a and apart from the outer periphery of the coil 424a.

In the driving mechanism disclosed in the Japanese Patent Application Laid-Open No. 2020-64284, since a line connecting the centers of the magnets arranged on both sides of the coil is displaced from the center of the coil, an efficiency of the driving mechanism decreases. In order to attach the driving mechanism to the lens apparatus without lowering the efficiency of the driving mechanism, it is necessary to provide a large opening in a holding barrel that holds the driving mechanism, as shown in International Publication No. WO2023/048001. However, if the large opening is provided in the holding barrel, a strength of the holding barrel cannot be secured sufficiently, and the lens may fall down when the holding barrel is assembled, when the temperature environment changes, or when the holding barrel is shocked, and the optical performance may decrease. Therefore, it is necessary to increase the outer diameter of the holding barrel in order to secure the strength of the holding barrel, and the lens apparatus becomes large.

On the other hand, according to the first embodiment, it is not necessary to insert the entire driving mechanism portion 801 through the opening portion 601s, so that as viewed along the optical axis direction OD, the opening portion 601s of the base 601 can be made smaller than a size (outer diameter) of a space in which the driving mechanism portion 801 is arranged. In the first embodiment, the opening portion 601s through which the fourth group unit 400 is inserted into the base 601 is provided on the rear side (image side). However, the opening portion 601s may be provided on the front side (object side) and the fourth group unit 400 may be inserted into the base 601 from the front side (object side).

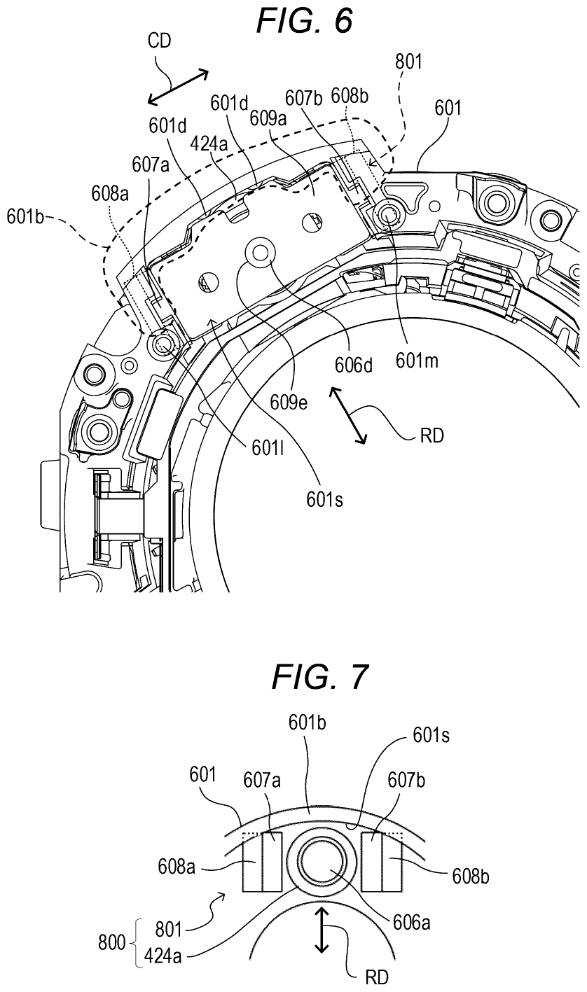

FIG. 6 is a view of the base 601, in which the driving mechanism portion 801 of the first embodiment is incorporated, as viewed from the rear. The base 601 has a connecting portion 601b connecting to close on an outer periphery side of the opening portion 601s. As viewed from the rear side of the base 601 with respect to the optical axis direction OD, the connecting portion 601b is arranged outside the coil 424a provided in the barrel base 403. Therefore, the opening portion 601s allows the coil 424a to pass through the opening portion 601s. The connecting portion 601b is integrally formed with the base 601 and may constitute a part of the base 601. As viewed from the rear side (other side) of the center yoke 606a with respect to the optical axis direction OD, i.e., as viewed along the optical axis direction OD from a side, on which the opening portion 601s is provided, of the base 601, the connecting portion 601b overlaps with the back yokes 608a and 608b so that the connecting portion 601b is arranged in front of the back yokes 608a and 608b. Since the connecting portion 601b connects the outer periphery of the opening portion 601s, an annular portion surrounding the opening portion 601s is formed in the base 601, thereby ensuring the strength of the base 601.

FIG. 7 is a schematic view showing a relationship between the driving mechanism portion 801 and the connecting portion 601b of the first embodiment. As shown in FIG. 7, as viewed along the optical axis direction OD from the rear side, the connecting portion 601b overlaps the back yokes 608a and 608b. With this configuration, the annular portion surrounding the opening portion 601s can be provided whole around the opening portion 601s without providing the opening portion 601s having an outer diameter larger than the outer diameter of the space in which the back yokes 608a and 608b are arranged. That is, the driving mechanism portion 801 can be held without increasing the diameter of the base 601. That is, the lens barrel 1 can be reduced in size.

As viewed along the radial direction RD from the outside of the outer periphery of the base 601, the connecting portion 601b overlaps the rear cylindrical portion 606d. Therefore, the base 601 can be reduced in size in the radial direction RD without enlarging the base 601 in the optical axis direction OD.

Next, the structure of the driving mechanism portion 801 will be described in more detail. As shown in FIG. 5A, the base 601 is provided with a regulating surface 601e and a regulating surface 601g in an inner portion on the front side with respect to the optical axis direction OD. The regulating surface 601e abuts against an inner surface of one end portion of the front base yoke 605a and against an inner surface of one end portion of the back yoke 608a to regulate the positions of the front base yoke 605a and the back yoke 608a in the radial direction RD orthogonal to the optical axis direction OD. The regulating surface 601g abuts against an inner surface of the other end portion of the front base yoke 605a and against an inner surface of one end portion of the back yoke 608b to regulate the positions of the front base yoke 605a and the back yoke 608b in the radial direction RD orthogonal to the optical axis direction OD.

The base 601 is provided with a protruding portion 601i, a protruding portion 601j and a protruding portion 601k protruding toward the rear side on the outer portion on the front side with respect to the optical axis direction OD (FIG. 4, FIG. 5A, and FIG. 5B). The front base yoke 605a is arranged between the regulating surface 601e and the protruding portion 601i and between the regulating surface 601g and the protruding portion 601j. The regulating surface 601e and the regulating surface 601g abut against the inner surface of the front base yoke 605a, and the protruding portion 601i and the protruding portion 601j abut against the outer surface of the front base yoke 605a, thereby positioning the front base yoke 605a in the radial direction RD.

A recessed portion 605d is provided on the outer surface of the front base yoke 605a. The protruding portion 601k of the base 601 is fitted into the recessed portion 605d of the front base yoke 605a, and thus the front base yoke 605a is positioned in the circumferential direction CD. As described above, since the positioning portion is provided on the outside of the front base yoke 605a, the front base yoke 605a can be positioned without lowering the magnetic efficiency of the front base yoke 605a.

The position of the front base yoke 605a with respect to the base 601 is determined by the regulating surface 601e, the regulating surface 601g, the protruding portion 601i, the protruding portion 601j, and the protruding portion 601k as positioning portions. The front cylindrical portion 606c of the center yoke 606a is inserted into both the hole of the base 601 and the hole 605e (FIG. 3) of the front base yoke 605a. The front cylindrical portion 606c (one end portion) of the center yoke 606a is held by the hole of the base 601. Here, when the hole 605e of the front base yoke 605a is smaller than the hole of the base 601, the clearance between the center cylindrical portion 606e of the center yoke 606a and the inner periphery of the coil 424a can be reduced, and the driving efficiency can be increased.

As shown in FIG. 6, the connecting portion 601b comprising a part of the base 601 is provided outside the rear base yoke 609a with respect to the radial direction RD. The connecting portion 601b at least partially covers the rear base yoke 609a. As shown in FIG. 5A, as viewing the hole portion 601c along the radial direction RD from the outside of the base 601, the connecting portion 601b overlaps with the rear base yoke 609a so that the connecting portion 601b is arranged in front of the rear base yoke 609a. As shown in FIG. 6, in a case where the hole 609e of the rear base yoke 609a into which the rear cylindrical portion 606d of the center yoke 606a is inserted is a round hole, the rear base yoke 609a rotates around the rear cylindrical portion 606d. Therefore, regulating portions 601d (FIG. 6) that abut against the rear base yoke 609a on both sides of the hole 609e with respect to the circumferential direction CD are provided on the inner portion of the connecting portion 601b. As the regulating portions 601d provided on the connecting portion 601b abut against the outer portion of the rear base yoke 609a, the rotation of the rear base yoke 609a around the rear cylindrical portion 606d is regulated. In other words, the driving mechanism portion 801 can be stably assembled into the base 601.

As shown in FIG. 5A, a regulating surface 601f and a regulating surface 601h are provided on the inner portion of the base 601 on the rear side with respect to the optical axis direction OD. The regulating surface 601f is provided on the rear side with respect to the regulating surface 601e with the VCM magnet 607a therebetween. The regulating surface 601h is provided on the rear side with respect to the regulating surface 601g with the VCM magnet 607b therebetween. The regulating surface 601f abuts against the inner surface of the other end portion of the back yoke 608a. The regulating surface 601h abuts against the inner surface of the other end portion of the back yoke 608b. The back yoke 608a abuts against the regulating surfaces 601e and 601f (a plurality of second regulating portions) to position the back yoke 608a in the radial direction RD. The back yoke 608b abuts against the regulating surfaces 601g and 601h (the plurality of second regulating portions) to position the back yoke 608b in the radial direction RD. With this configuration, the front base yoke 605a and/or the rear base yoke 609a can be reduced in size, and the size of the opening portion 601s (FIG. 6) can be reduced. By efficiently arranging the necessary components and reducing the opening portion 601s in size, the lens barrel 1 can be reduced in size in the radial direction RD.

The rear cylindrical portion 606d of the center yoke 606a is inserted into both a hole of the fifth lens barrel (holding member) 502 and the hole 609e (FIG. 6) of the rear base yoke 609a. The rear cylindrical portion 606d (the other end portion) of the center yoke 606a is held by the hole of the fifth lens barrel 502. The fifth lens barrel 502 is fixed to the base 601 by tightening screws 703a and 703b (FIG. 4) into screw holes (fixing portions) 601l and 601m provided in the base 601. As shown in FIG. 4 and FIG. 6, the screw hole 601l is provided in the base 601 so that as viewed from the rear side with respect to the optical axis direction OD, the screw hole 601l overlaps with the back yoke 608a while the screw hole 601l is arranged in front of the back yoke 608a. Similarly, the screw hole 601m is provided in the base 601 so that as viewed from the rear side with respect to the optical axis direction OD, the screw hole 601m overlaps with and the back yoke 608b while the screw hole 601m is arranged in front of the back yoke 608b. The screw holes 601l and 601m are provided at positions close to the center yoke 606a. Since the fifth lens barrel 502, which is a holding member, can be fixed to the base 601 at the positions close to the center yoke 606a having weight, the center yoke 606a can be stably held.

As shown in FIG. 5A, the base 601 is provided with regulating surfaces 601n and 6010, and 601p and 601q (a plurality of first regulating portions), the regulating surfaces 601n and 601p being arranged opposite to the regulating surfaces 6010 and 601q, respectively, in the optical axis direction OD. The back yoke 608a is arranged between the regulating surface 601n and the regulating surface 601o, as shown in FIG. 5B. The position of the back yoke 608a in the optical axis direction OD is regulated by the regulating surface 601n and the regulating surface 601o. The regulating surface 601n and the regulating surface 601o function as positioning portions configured to position the back yoke 608a in the optical axis direction OD. The back yoke 608b is arranged between the regulating surface 601p and the regulating surface 601q, as shown in FIG. 5B. The position of the back yoke 608b in the optical axis direction OD is regulated by the regulating surface 601p and the regulating surface 601q. The regulating surface 601p and the regulating surface 601q function as positioning portions configured to position the back yoke 608b in the optical axis direction OD.

As described above, the position of the back yoke 608a in the optical axis direction OD is determined by the regulating surface 601n and the regulating surface 601o provided on the base 601. The position of the coil 424a is determined by the position of the fourth group unit 400 which holds the coil 424a. The position of the fourth group unit 400 is determined by the specification of the optical system. According to the first embodiment, since the back yoke 608a to which the VCM magnet 607a is attracted is positioned by the regulating surface 601n and the regulating surface 601o provided on the base 601, the assembly error of the VCM magnet 607a and the coil 424a can be reduced. In other words, it is possible to suppress the lowering in the driving efficiency of the driving mechanism near the end portions of the movable range of the fourth group unit 400, for example, comparing with the case where the position of the back yoke 608a is determined by the front base yoke 605a and the rear base yoke 609a. The same effect can be obtained for the back yoke 608b.

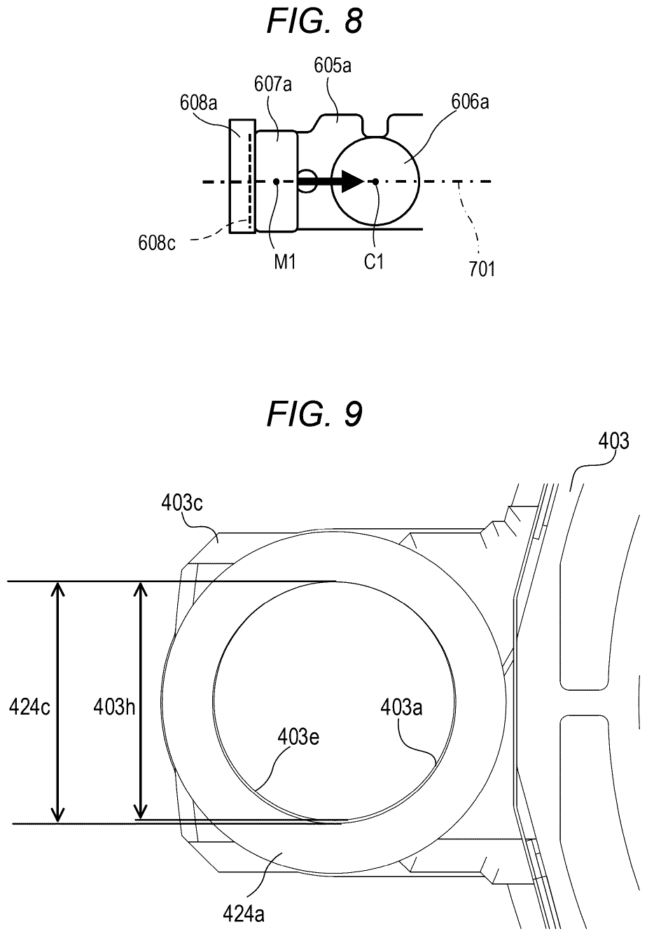

FIG. 8 is a schematic view showing a relationship among abutting positions of the back yoke 608a, the front base yoke 605a, and the rear base yoke 609a of the first embodiment. The back yoke 608a is magnetically attracted by the VCM magnet 607a and abuts against the front base yoke 605a and the rear base yoke 609a. Referring to FIG. 3, the first contact surface 608a1 of the back yoke 608a abuts against the front base yoke 605a. The second contact surface 608a2 of the back yoke 608a abuts against the rear base yoke 609a. An attracting surface 608a3 of the back yoke 608a is attracted to the VCM magnet 607a. The first contact surface 608a1, the second contact surface 608a2, and the attracting surface 608a3 of the back yoke 608a are provided on the same plane. This same plane is referred to as an abutment surface 608c (FIG. 3 and FIG. 8).

As shown in FIG. 8, a line 701 is a straight line passing through a center M1 of the VCM magnet 607a (one magnet) and a center C1 of the center yoke 606a. The line 701 intersects the abutment surface 608c. In the first embodiment, as viewed along the optical axis direction OD, the line 701 is substantially orthogonal to the abutment surface 608c and passes through the abutment surface 608c. An attracting force generated on the back yoke 608a toward the center yoke 606a is directed substantially on the line 701 toward the center yoke 606a. With this configuration, even when the back yoke 608a is attracted to and abuts against one surface, which is the flat surface portion 605a1, of the front base yoke 605a, the back yoke 608a is held by the front base yoke 605a without falling toward the coil 424a. For example, in order to prevent the back yoke 608a from falling, it is conceivable that a recessed portion is provided at one end portion of the back yoke 608a, a projection portion is provided on the flat surface portion 605a1 of the front base yoke 605a, and the projection portion is fitted into the recessed portion of the back yoke 608a. However, according to the first embodiment, since the back yoke 608a can be held in contact with the one surface which is the flat surface portion 605a1 of the front base yoke 605a, it is not necessary to provide such a projection portion on a side, close to the back yoke 608a, of the front base yoke 605a. As a result, since a width of the front base yoke 605a in the circumferential direction can be reduced in size, the opening portion 601s of the base 601 can be reduced in size, the necessary components can be efficiently arranged, and the lens barrel 1 can be reduced in size. The same applies to the rear base yoke 609a.

As shown in FIG. 5B, the back yokes 608a and 608b are fixed by adhesive at one or more adhesive positions 702 between the back yokes 608a, 608b and the front base yoke 605a and/or between the back yokes 608a, 608b and the rear base yoke 609a. The back yokes 608a and 608b are held by magnetic attraction between the VCM magnets 607a and 607b and the center yoke 606a, but they are held more firmly by fixing them with adhesive. The back yokes 608a and 608b may be fixed to at least one of the base 601, the front base yoke 605a, and the rear base yoke 609a by an adhesive.

FIG. 9 is a cross-sectional view showing a holding relationship between the coil 424a and the barrel base 403 of the first embodiment. With reference to FIG. 2A, FIG. 2B, and FIG. 9, a holding method of the coil 424a by the barrel base 403 will be described. As described above, the coil 424a is held between the front holding portion 403c and the rear holding portion 403d provided on the barrel base 403. The front holding portion 403c (first covering portion) is arranged on the front side (one side) with respect to the coil 424a in the optical axis direction OD and covers a front end portion (one end portion) of the coil 424a. The rear holding portion 403d (second covering portion) is arranged on the rear side (the other side) with respect to the coil 424a in the optical axis direction OD and covers a rear end portion (the other end portion) of the coil 424a. The front holding portion 403c is provided with the front hole portion (first hole portion) 403a through which the center yoke 606a extends (FIG. 2A, FIG. 2B, and FIG. 4). The rear holding portion 403d is provided with the rear hole portion (second hole portion) 403b through which the center yoke 606a extends (FIG. 4). The coil 424a is fixed by adhesive in a front adhesive groove 403e provided in the front holding portion 403c, a rear adhesive groove 403f provided in the rear holding portion 403d, and an adhesive groove 403g provided on a side, close to the optical axis 7, with respect to the coil 424a.

A hole diameter 403h (first inner diameter) of the front hole portion 403a is the same as or smaller than an inner diameter 424c of the coil 424a. As viewed along the optical axis direction OD, a circle constituting the front hole portion 403a is placed in a circle constituting the inner diameter 424c of the coil 424a. A hole diameter (second inner diameter) of the rear hole portion 403b is also the same as or smaller than the inner diameter 424c of the coil 424a. As viewed along the optical axis direction OD, a circle constituting the rear hole portion 403b is placed in the circle constituting the inner diameter 424c of the coil 424a. That is, hole portions having the same diameter as or a diameter smaller than the inner diameter 424c of the coil 424a are provided in front and rear of the coil 424a, respectively. With such a configuration, even if the fourth group unit 400 is inclined relative to the center yoke 606a, the center yoke 606a abuts against the front hole portion 403a or the rear hole portion 403b before the coil 424a abuts. Generally, when an impact is applied in assembling or dropping, the coil 424a and the center yoke 606a abut against each other and come off. Therefore, in the prior art, the clearance between the coil 424a and the center yoke 606a is increased to some extent. However, if the clearance is increased, the driving efficiency of the driving mechanism is lowered. On the other hand, according to the first embodiment, since the center yoke 606a abuts against the front hole portion 403a or the rear hole portion 403b, a force is not applied only to the coil 424a. Therefore, the clearance between the coil 424a and the center yoke 606a can be reduced to increase the driving efficiency. In other words, the driving mechanism can be reduced in size so that the lens barrel 1 can be reduced in size. According to the first embodiment, it is possible to provide the lens barrel 1 which is small but has sufficient strength without lowering the driving efficiency.

### Second Embodiment

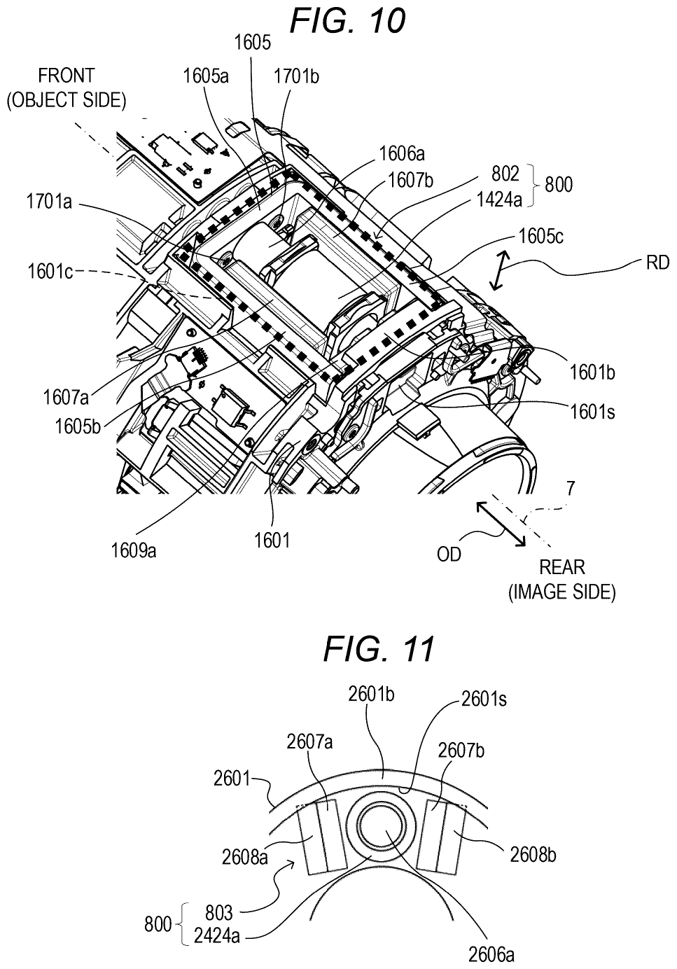

Hereinafter, a second embodiment will be described. Since the imaging apparatus 10 of the second embodiment has the same structure as that of the imaging apparatus 10 of the first embodiment except for a driving mechanism portion 802, the description of the imaging apparatus 10 will be omitted. Hereinafter, with reference to FIG. 10, the driving mechanism portion 802 of the second embodiment will be described. FIG. 10 is a perspective view of the driving mechanism portion 802 of the second embodiment. The driving mechanism 800 configured to drive the barrel unit 404 has the driving mechanism portion 802 and a coil 1424a. The driving mechanism portion 802 includes a base yoke 1605, a center yoke 1606a, VCM magnets 1607a and 1607b, and a rear base yoke 1609a. The base yoke 1605 is formed in a square bracket shape. The base yoke 1605 has a front base yoke portion 1605a, and a first back yoke portion (first side) 1605b and a second back yoke portion (second side) 1605c extending from both end portions of the front base yoke portion 1605a toward the rear side, respectively. The front base yoke portion 1605a as a third magnetic material portion and the first back yoke portion 1605b and the second back yoke portion 1605c as a plurality of second magnetic material portions are integrally formed into one body. The front base yoke portion 1605a is arranged to abut against the base 1601 in the optical axis direction OD on the front side of the center yoke 1606a with respect to the optical axis direction OD. The front base yoke portion 1605a is fixed to the base 1601 by tightening screws (fixing members) 1701a and 1701b from the side on which the center yoke 1606a is arranged (rear side) toward the front side. The front base yoke portion (third magnetic material portion) 1605a magnetically joins the center yoke 1606a with the first back yoke portion 1605b and the second back yoke portion 1605c (the plurality of second magnetic material portions).

The first back yoke portion 1605b and the second back yoke portion 1605c are arranged opposite to each other with the coil 1424a interposed therebetween. The VCM magnets 1607a and 1607b are magnetically attracted and fixed to the coil sides of the first back yoke portion 1605b and the second back yoke portion 1605c, respectively. The VCM magnets 1607a and 1607b are arranged so that the same poles face the coil 1424a. The VCM magnets 1607a and 1607b are arranged opposite to an outer periphery of the coil 1424a and apart from the outer periphery of the coil 1424a.

The center yoke (first magnetic material portion) 1606a is arranged inside the coil 1424a and apart from an inner periphery (inner peripheral surface) of the coil 1424a (with a clearance (gap) between the center yoke 1606a and the inner periphery of the coil 1424a) and is fixed to the base 1601. A rear base yoke (fourth magnetic material portion) 1609a is arranged on the rear side (the other side) of the center yoke 1606a with respect to the optical axis direction OD. The rear base yoke 1609a is attracted by the magnetic force of the VCM magnets (magnets) 1607a and 1607b and is in contact with the base yoke 1605 and the center yoke 1606a. The rear base yoke 1609a magnetically joins the center yoke 1606a with the first back yoke portion 1605b and the second back yoke portion 1605c. The magnetic circuit is composed of the above configuration.

As in the first embodiment, the base 1601 has a connecting portion 1601b connecting to close on an outer periphery side of an opening portion 1601s. The connecting portion 1601b may be integrally formed with the base 1601 and may constitute a part of the base 1601 as one body. Since the connecting portion 1601b connects the outer periphery of the opening portion 1601s, an annular portion surrounding the opening portion 1601s is formed in the base 1601, thereby ensuring the strength of the base 1601. As viewed from the rear side (the other side) of the center yoke 1601a with respect to the optical axis direction OD, the connecting portion 1601b is arranged in front of the first back yoke portion 1605b and the second back yoke portion 1605c. Then, the connecting portion 1601b overlaps with a part of the first back yoke portion 1605b and a part of the second back yoke portion 1605c. In other words, as in the first embodiment, the lens barrel 1 can be reduced in size while ensuring the strength of the base 1601 by providing the connecting portion 1601b.

The base 1601 is provided with a hole portion (an outer diameter hole portion) 1601c indicated by a dotted line in FIG. 10 in the outer periphery of the base 1601. The hole portion 1601c has a size that allows each of the base yoke 1605 formed in the square bracket shape and the VCM magnets 1607a and 1607b to pass through the hole portion 1601c. The first back yoke portion 1605b and the second back yoke portion 1605c can be seen from the outside of the outer periphery of the base 1601 through the hole portion 1601c. In the second embodiment, as viewing the hole portion 1601c from the outside of the base 1601, the hole portion 1601c is approximately the same as or larger than the base yoke 1605 to which the VCM magnets 1607a and 1607b are attracted. In other words, the base yoke 1605 to which the VCM magnets 1607a and 1607b are attracted as a united state can be assembled into the base 1601 through the hole portion 1601c from the outside of the outer periphery of the base 1601.

As in the first embodiment, the connecting portion 1601b composed of the part of the base 1601 is arranged outside the rear base yoke 1609a with respect to the radial direction RD orthogonal to the optical axis direction OD. As viewing the hole portion 1601c along the radial direction RD from the outside of the base 1601, the connecting portion 1601b overlaps with the rear base yoke 1609a so that the connecting portion 1601b is arranged in front of the rear base yoke 1609a. Thus, the base 1601 can be reduced in size without enlarging the base 1601 in the optical axis direction OD. According to the second embodiment, it is possible to provide the lens barrel 1 which is small but has sufficient strength without lowering the driving efficiency.

### Third Embodiment

Hereinafter, a third embodiment will be described. Since the imaging apparatus 10 of the third embodiment has the same structure as that of the imaging apparatus 10 of the first embodiment except for a driving mechanism portion 803, the description of the imaging apparatus 10 will be omitted. Hereinafter, with reference to FIG. 11, the driving mechanism portion 803 of the third embodiment will be described.

FIG. 11 is a schematic view showing a relationship between the driving mechanism portion 803 and a connecting portion 2601b of the third embodiment. The driving mechanism 800 configured to drive the barrel unit 404 has the driving mechanism portion 803 and a coil 2424a. The driving mechanism portion 803 includes a front base yoke, a center yoke 2606a, VCM magnets 2607a and 2607b, back yokes 2608a and 2608b, and a rear base yoke. The center yoke (first magnetic material portion) 2606a is arranged inside the coil 2424a and apart from an inner periphery (inner peripheral surface) of the coil 2424a with a clearance (gap) between the center yoke 2606a and the inner periphery of the coil 2424a and is fixed to a base 2601. As shown in FIG. 11, the back yokes 2608a and 2608b (a plurality of second magnetic material portions) are arranged in a V-shape. The VCM magnets 2607a and 2607b are magnetically attracted and fixed to the respective coil sides of the back yokes 2608a and 2608b with the same magnetic poles facing each other and are arranged in the V-shape. The VCM magnets 2607a and 2607b are arranged opposite to an outer periphery of the coil 2424a and apart from the outer periphery of the coil 2424a.

As viewed along the optical axis direction OD from the rear side (the other side) of the center yoke 2606a, the connecting portion 2601b is arranged in front of the back yokes 2608a and 2608b, and the connecting portion 2601b overlaps with a part of the back yokes 2608a and 2608b. Also in the third embodiment, as viewed along the optical axis direction OD, an opening portion 2601s can be made smaller than a size (outer diameter) of a space in which the back yokes 2608a and 2608b are arranged, and the base 2601 can be provided with an annular portion that surrounds the opening portion 2601s. In other words, the driving mechanism portion 803 can be held without increasing a diameter of the base 2601. Therefore, the lens barrel 1 can be reduced in size. According to the third embodiment, it is possible to provide the lens barrel 1 which is small but has sufficient strength without lowering the driving efficiency.

### Fourth Embodiment

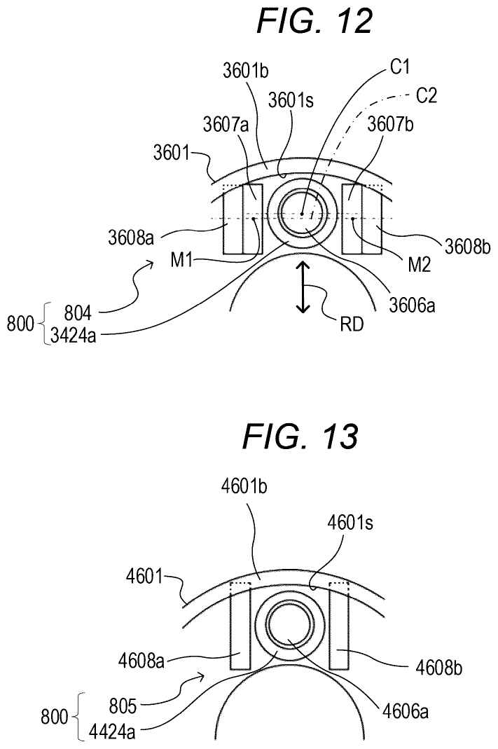

Hereinafter, a fourth embodiment will be described. Since the imaging apparatus 10 of the fourth embodiment has the same structure as that of the imaging apparatus 10 of the first embodiment except for a driving mechanism portion 804, the description of the imaging apparatus 10 will be omitted. Hereinafter, with reference to FIG. 12, the driving mechanism portion 804 of the fourth embodiment will be described.

FIG. 12 is a schematic view showing a relationship between the driving mechanism portion 804 and a connecting portion 3601b of the fourth embodiment. The driving mechanism 800 configured to drive the barrel unit 404 has the driving mechanism portion 804 and a coil 3424a. The driving mechanism portion 804 includes a front base yoke, a center yoke 3606a, VCM magnets 3607a and 3607b, back yokes 3608a and 3608b, and a rear base yoke. The center yoke (first magnetic material portion) 3606a is arranged inside the coil 3424a and apart from an inner periphery (inner peripheral surface) of the coil 3424a (with a clearance (gap) between the center yoke 3606a and the inner periphery of the coil 3424a) and is fixed to a base 3601. The VCM magnets 3607a and 3607b are arranged opposite to an outer periphery of the coil 3424a and apart from the outer periphery of the coil 3424a. As shown in FIG. 12, the back yokes 3608a and 3608b (a plurality of second magnetic material portions) are arranged opposite to each other with the coil 3424a interposed therebetween. The back yoke 3608a to which the VCM magnet 3607a is attracted and the back yoke 3608b to which the VCM magnet 3607b is attracted are arranged opposite to the center yoke 3606a. A center C1 of the center yoke 3606a is arranged outside a center M1 of the VCM magnet 3607a and a center M2 of the VCM magnet 3607b in the radial direction RD. That is, a distance from the optical axis 7 to the center C1 of the center yoke 3606a is larger than a distance from the optical axis 7 to the straight line C2 connecting the center M1 of the VCM magnet 3607a and the center M2 of the VCM magnet 3607b.

As viewed along the optical axis direction OD from the rear side (the other side) of the center yoke 3606a, the connecting portion 3601b is arranged in front of the back yokes 3608a and 3608b, and the connecting portion 3601b overlaps with a part of the back yokes 3608a and 3608b. Also in the fourth embodiment, as viewed along the optical axis direction OD, an opening portion 3601s can be made smaller than a size (outer diameter) of a space in which the back yokes 3608a and 3608b are arranged, and the base 3601 can be provided with an annular portion that surrounds the opening portion 3601s. In other words, the driving mechanism portion 804 can be held without increasing a diameter of the base 3601. Therefore, the lens barrel 1 can be reduced in size. According to the fourth embodiment, it is possible to provide the lens barrel 1 which is small but has sufficient strength without lowering the driving efficiency.

### Fifth Embodiment

Hereinafter, a fifth embodiment will be described. Since the imaging apparatus 10 of the fifth embodiment has the same structure as that of the imaging apparatus 10 of the first embodiment except for a driving mechanism portion 805, the description of the imaging apparatus 10 will be omitted. Hereinafter, with reference to FIG. 13, the driving mechanism portion 805 of the fifth embodiment will be described.

FIG. 13 is a schematic view showing a relationship between the driving mechanism portion 805 and a connecting portion 4601b of the fifth embodiment. The driving mechanism 800 configured to drive the barrel unit 404 has the driving mechanism portion 805 and a coil 4424a. The driving mechanism portion 805 includes a front base yoke, a magnet unit 4606a, side yokes 4608a and 4608b, and a rear base yoke. The barrel base 403 of the fourth group unit 400 holds the coil 4424a as in the first embodiment. The magnet unit 4606a is arranged inside the coil 4424a and apart from an inner periphery (inner peripheral surface) of the coil 4424a (with a clearance (gap) between the magnet unit 4606a and the inner periphery of the coil 4424a) and fixed to a base 4601. The magnet unit 4606a has a magnetic pole in the optical axis direction OD and comprises a plurality of magnets. For example, the magnet unit 4606a may be constituted by arranging a plurality of cylindrical magnets in the optical axis direction OD. The magnet unit 4606a may comprise a single magnet.

The side yokes (a plurality of first magnetic material portions) 4608a and 4608b are arranged opposite to an outer periphery of the coil 4424a and apart from the outer periphery of the coil 4424a. A front base yoke as a second magnetic material portion is arranged on the front side (one side) of the magnet unit 4606a with respect to the optical axis direction OD, and the front base yoke magnetically joins the magnet unit 4606a with the side yokes 4608a and 4608b. The rear base yoke as a third magnetic material portion is arranged on the rear side (the other side) of the magnet unit 4606a with respect to the optical axis direction OD, and the rear base yoke magnetically joins the magnet unit 4606a with the side yokes 4608a and 4608b. The side yokes 4608a and 4608b may be further fixed by an adhesive to the front base yoke and/or the rear base yoke.

The front base yoke is arranged in abutment with the base 4601 in the optical axis direction OD on the front side of the magnet unit 4606a with respect to the optical axis direction OD. The front base yoke is fixed to the base 4601 by a fixing member such as a screw from the rear side with respect to the optical axis direction OD. The base 4601 has a connecting portion 4601b connecting to close on an outer periphery side of an opening portion 4601s. The connecting portion 4601b may be integrally formed with the base 4601 and may constitute a part of the base 4601 as one body. As viewed along the optical axis direction OD from the rear side of the magnet unit 4606a, the connecting portion 4601b is arranged in front of the side yokes 4608a and 4608b, and the connecting portion 4601b overlaps with a part of the side yokes 4608a and 4608b. Also in the fifth embodiment, as viewed along the optical axis direction OD, an opening portion 4601s can be made smaller than a size (outer diameter) of a space in which the side yokes 4608a and 4608b are arranged, and the base 4601 can be provided with an annular portion that surrounds the opening portion 4601s. In other words, the driving mechanism portion 805 can be held without increasing a diameter of the base 4601. Therefore, the lens barrel 1 can be reduced in size. According to the fifth embodiment, it is possible to provide the lens barrel 1 which is small but has sufficient strength without lowering the driving efficiency.

In the first to fifth embodiments, the regulating surfaces for the radial direction RD of the back yokes are provided within the range in the optical axis direction where the front and rear base yokes are arranged. However, the regulating surfaces for the radial direction RD of the back yokes may be provided outside the front and rear base yokes with respect to the optical axis direction. For example, protrusions (stepped portions) extending outward in the optical axis direction with respect to the front and rear base yokes from outer portions in the radial direction RD of both end portions of the back yoke in the optical axis direction are provided. The positions in the radial direction RD of the back yoke may be regulated by making inner surfaces in the radial direction RD of the protrusions (stepped portions) abut against the regulating surfaces provided on the base.

In the first to fifth embodiments, the back yoke (side yoke) may be further fixed by adhesive to the front base yoke and the rear base yoke, but the back yoke (side yoke) may be fixed to the base by adhesive. In the first to fifth embodiments, the coil is formed in a circular shape, but the coil may be formed in a square shape to obtain the same effect.

In the imaging apparatus 10 of the embodiments, the lens barrel 1 is an interchangeable lens detachably mounted on the camera body 2. However, the imaging apparatus may be a camera in which the lens barrel and the camera body are integrally formed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-082416, filed May 21, 2024, which is hereby incorporated by reference herein in its entirety.

What is claimed is:

1. A lens apparatus, comprising:
a moving member configured to hold a lens and to be movable in an optical axis direction;
a holding barrel configured to hold the moving member; and
a driving mechanism configured to move the moving member,
wherein the driving mechanism includes:
a coil held by the moving member; and
a magnetic material portion held by the holding barrel,
wherein an outer periphery of the holding barrel is provided with an opening portion, and
wherein when viewed in the optical axis direction, a part of the outer periphery overlaps with a part of the magnetic material portion so that the part of the outer periphery is arranged outside the part of the magnetic material portion.

2. The lens apparatus according to claim 1, wherein the magnetic material portion includes:
a first magnetic material portion arranged inside the coil and apart from an inner periphery of the coil;
a plurality of magnets arranged opposite to an outer periphery of the coil and apart from the outer periphery of the coil;
a plurality of second magnetic material portions holding the plurality of magnets, respectively;
a third magnetic material portion arranged on one side of the first magnetic material portion with respect to the optical axis direction and magnetically joining the first magnetic material portion and the plurality of second magnetic material portions; and
a fourth magnetic material portion arranged on the other side of the first magnetic material portion with respect to the optical axis direction and magnetically joining the first magnetic material portion and the plurality of second magnetic material portions,
wherein the third magnetic material portion is arranged in abutment with the holding barrel in the optical axis direction on the one side of the first magnetic material portion with respect to the optical axis direction, and
wherein as viewed along the optical axis direction from the other side of the first magnetic material portion, a part of the holding barrel overlaps with the plurality of second magnetic material portions so that the part of the holding barrel is arranged in front of the plurality of second magnetic material portions.

3. The lens apparatus according to claim 2, wherein the holding barrel is provided with a hole portion in an outer periphery of the holding barrel so that the plurality of second magnetic material portions can be seen through the hole portion.

4. The lens apparatus according to claim 3, wherein the hole portion has such a size that each of the plurality of magnets and the plurality of second magnetic material portions can pass through the hole portion.

5. The lens apparatus according to claim 3, wherein as viewing the hole portion along a direction orthogonal to the optical axis direction from an outside of the holding barrel, a part of the holding barrel overlaps with the fourth magnetic material portion so that the part of the holding barrel is arranged in front of the fourth magnetic material portion.

6. The lens apparatus according to claim 2, wherein the holding barrel includes a plurality of first regulating portions configured to regulate positions of the plurality of second magnetic material portions in the optical axis direction, respectively.

7. The lens apparatus according to claim 2, wherein the holding barrel includes a plurality of second regulating portions configured to regulate positions of the plurality of second magnetic material portions in a direction orthogonal to the optical axis direction, respectively.

8. The lens apparatus according to claim 2, wherein one end portion of the first magnetic material portion is held by the holding barrel,
wherein the lens apparatus further comprises a holding member configured to hold the other end portion of the first magnetic material portion, and
wherein as viewed along the optical axis direction from the other side of the first magnetic material portion, a fixing portion configured to fix the holding member to the holding barrel overlaps with the second magnetic material portions so that the fixing portion is arranged in front of the second magnetic material portions.

9. The lens apparatus according to claim 2, wherein the plurality of second magnetic material portions are fixed to at least one of the holding barrel, the third magnetic material portion and the fourth magnetic material portion by an adhesive.

10. The lens apparatus according to claim 2, wherein the third magnetic material portion is fixed to the holding barrel by a fixing member from a side on which the first magnetic material portion is to be arranged.

11. The lens apparatus according to claim 2, wherein the plurality of second magnetic material portions, the third magnetic material portion, and the fourth magnetic material portion are separate bodies.

12. The lens apparatus according to claim 2, wherein as viewed along the optical axis direction, a straight line connecting a center of one magnet of the plurality of magnets and a center of the first magnetic material portion intersects a first contact surface at which one second magnetic material portion of the plurality of second magnetic material portions holding the one magnet contacts the third magnetic material portion, and a second contact surface at which the one second magnetic material portion contacts the fourth magnetic material portion.

13. The lens apparatus according to claim 2, wherein the plurality of second magnetic material portions and the third magnetic material portion are one body.

14. The lens apparatus according to claim 1, wherein the magnetic material portion includes:
a first magnetic material portion arranged inside the coil and apart from an inner periphery of the coil;
a plurality of magnets arranged opposite to an outer periphery of the coil and apart from the outer periphery of the coil;
a plurality of second magnetic material portions holding the plurality of magnets, respectively;
a third magnetic material portion arranged on one side of the first magnetic material portion with respect to the optical axis direction and magnetically joining the first magnetic material portion and the plurality of second magnetic material portions; and
a fourth magnetic material portion arranged on the other side of the first magnetic material portion with respect to the optical axis direction and magnetically joining the first magnetic material portion and the plurality of second magnetic material portions,
wherein the holding barrel is provided with a hole portion in an outer periphery of the holding barrel so that the plurality of second magnetic material portions can be seen through the hole portion.

15. A lens apparatus, comprising:
a holding barrel;
a moving member configured to hold a lens and held by the holding barrel so as to be movable in an optical axis direction;
a coil fixed to the moving member;
a first magnetic material portion arranged inside the coil and apart from an inner periphery of the coil;
a plurality of magnets arranged opposite to an outer periphery of the coil and apart from the outer periphery of the coil;
a plurality of second magnetic material portions holding the plurality of magnets, respectively;
a third magnetic material portion arranged on one side of the first magnetic material portion with respect to the optical axis direction and magnetically joining the first magnetic material portion and the plurality of second magnetic material portions; and
a fourth magnetic material portion arranged on the other side of the first magnetic material portion with respect to the optical axis direction and magnetically joining the first magnetic material portion and the plurality of second magnetic material portions,
wherein the moving member includes:
a first covering portion arranged on one side of the coil with respect to the optical axis direction and covering one end portion of the coil; and
a second covering portion arranged on the other side of the coil with respect to the optical axis direction and covering the other end portion of the coil,
wherein the first covering portion is provided with a first hole portion through which the first magnetic material portion passes,
wherein the second covering portion is provided with a second hole portion through which the first magnetic material portion passes, and
wherein a first inner diameter of the first hole portion and a second inner diameter of the second hole portion are smaller than an inner diameter of the coil.

16. The lens apparatus according to claim 1, wherein the magnetic material portion includes:
a magnet unit arranged inside the coil and apart from an inner periphery of the coil;
a plurality of first magnetic material portions arranged opposite to an outer periphery of the coil and apart from the outer periphery of the coil;
a second magnetic material portion arranged on one side of the magnet unit with respect to the optical axis direction and magnetically joining the magnet unit and the plurality of first magnetic material portions; and
a third magnetic material portion arranged on the other side of the magnet unit with respect to the optical axis direction and magnetically joining the magnet unit and the plurality of first magnetic material portions,
wherein the second magnetic material portion is arranged in abutment with the holding barrel in the optical axis direction on the one side of the magnet unit with respect to the optical axis direction, and
wherein as viewed along the optical axis direction from the other side of the magnet unit, a part of the holding barrel overlaps with the plurality of first magnetic material portions so that the part of the holding barrel is arranged in front of the plurality of first magnetic material portions.

17. The lens apparatus according to claim 1, wherein the magnetic material portion includes:
a magnet unit arranged inside the coil and apart from an inner periphery of the coil;
a plurality of first magnetic material portions arranged opposite to an outer periphery of the coil and apart from the outer periphery of the coil;
a second magnetic material portion arranged on one side of the magnet unit with respect to the optical axis direction and magnetically joining the magnet unit and the plurality of first magnetic material portions; and
a third magnetic material portion arranged on the other side of the magnet unit with respect to the optical axis direction and magnetically joining the magnet unit and the plurality of first magnetic material portions,
wherein the holding barrel is provided with a hole portion in an outer periphery of the holding barrel so that the plurality of first magnetic material portions can be seen through the hole portion.

18. The lens apparatus according to claim 1, wherein the magnetic material portion includes:
a magnet unit arranged inside the coil and apart from an inner periphery of the coil;
a plurality of first magnetic material portions arranged opposite to an outer periphery of the coil and apart from the outer periphery of the coil;
a second magnetic material portion arranged on one side of the magnet unit with respect to the optical axis direction and magnetically joining the magnet unit and the plurality of first magnetic material portions; and
a third magnetic material portion arranged on the other side of the magnet unit with respect to the optical axis direction and magnetically joining the magnet unit and the plurality of first magnetic material portions,
wherein the moving member includes:
a first covering portion arranged on one side of the coil with respect to the optical axis direction and covering one end portion of the coil; and
a second covering portion arranged on the other side of the coil with respect to the optical axis direction and covering the other end portion of the coil,
wherein the first covering portion is provided with a first hole portion through which the magnet unit passes,
wherein the second covering portion is provided with a second hole portion through which the magnet unit passes, and
wherein a first inner diameter of the first hole portion and a second inner diameter of the second hole portion are smaller than an inner diameter of the coil.

19. The lens apparatus according to claim 1, wherein the lens apparatus is an interchangeable lens detachably mounted on a body of an imaging apparatus including an image sensor configured to pick up an image formed by the lens apparatus.

20. An imaging apparatus composing:
the lens apparatus as recited in claim 1; and
an image sensor configured to pick up an image formed by the lens apparatus.
